(19) United States
(12) Patent Application Publication
(10) Pub. No.: US 2026/0041075 A1
(43) Pub. Date: Feb. 12, 2026

(54) Snag Free Guides for Fishing Rods

(71) Applicant: Steven Pfister, Pasco, WA (US)

(72) Inventor: Steven Pfister, Pasco, WA (US)

(21) Appl. No.: 18/904,187

(22) Filed: Oct. 2, 2024

Related U.S. Application Data
(60) Provisional application No. 63/679,649, filed on Aug. 6, 2024.

(51) Int. Cl. A01K 87/04

(52) U.S. Cl. CPC A01K 87/04

(57) ABSTRACT

Snag free eyelets or guides for fishing poles or rods are disclosed. The device is a fishing pole with eyelets or guides that enables the pole to be snag free, thereby preventing fishing line from wrapping around the guides or fishing pole and preventing damage from impact to the guides. An overguide is opened over the top of the eyelet and can accommodate the wrapped line. Electrical tape, guide wrappings, or guide winding thread can be used to secure opposing ends of the overguide onto the fishing pole for stability. Looking at a side view of the guide, there is a wire that makes a ‘roof’ over the guide parallel with the fishing pole. Thus, the fishing line, and other contact items, can easily slip or slide over the top of the guide and avoid snagging.

### CROSS-REFERENCE TO RELATED APPLICATION

The present application claims priority to, and the benefit of, U.S. Provisional Application No. 63/679,649, which was filed on Aug. 6, 2024, and is incorporated herein by reference in its entirety.

### FIELD OF THE INVENTION

The present invention relates generally to the field of fishing pole devices. More specifically, the present invention relates to a fishing pole with eyelets or guides that eliminate snagging of the fishing line and/or guides. Accordingly, the present disclosure makes specific reference thereto. Nonetheless, it is to be appreciated that aspects of the present invention are also equally applicable to other like applications, devices, and methods of manufacture.

### BACKGROUND

By way of background, this invention relates to improvements in fishing pole devices. Generally, snags on fishing line and guides can occur when using a fishing pole, leading to tangles, broken lines, loosened or bent guides, and broken fishing rods. As it is known, several eyelets are present on longer fishing poles or rods, thus making snags more common. Constantly dealing with fishing line snags or guide snags instead of enjoying time fishing can be very frustrating.

Accordingly, there is a demand for improved snag free eyelets for fishing poles or rods that leads to less fishing line snags and less fishing guide snags. More particularly, there is a demand for snag free eyelets for fishing poles or rods that provides users with a snag free fishing pole that facilitates simple and convenient threading of fishing line through the eyelets.

Therefore, there exists a long-felt need in the art for snag free eyelets for fishing poles or rods that provides users with a snag free, convenient, and simple threading of fishing line through the eyelets. There is also a long-felt need in the art for snag free eyelets for fishing poles or rods that eliminates the need to constantly pull a pole back in and unhooking the line after the eyelets. Further, there is a long-felt need in the art for snag free eyelets for fishing poles or rods that makes it much easier and simpler for fishing line to transfer in and out of the eyelets (i.e., through the eyelets/guides) as the fishing line is cast. Finally, there is a long-felt need in the art for snag free eyelets or guides for fishing poles or rods that improves the overall fishing experience and that reduces the amount of fishing line tangles and guide snags that occur.

The subject matter disclosed and claimed herein, in one embodiment thereof, comprises snag free eyelets for fishing poles or rods. The device is a fishing pole with eyelets or guides that enables the pole to be snag free, thereby preventing fishing line from wrapping around the fishing pole, and bent or damaged fishing guides. An overguide or twisted pin is opened over the top of the eyelet or guide and can accommodate the wrapped line. Electrical tape, guide wrappings, or guide winding thread can be used to secure the pin for stability. Looking at a side view of the eyelet, there is a wire that makes a ‘roof’ over the eye parallel with the fishing pole. Thus, the fishing line can easily slip through the eyelet and avoid snagging, and obstacles can easily slip or slide over the guides without snagging the guides.

In this manner, the snag free eyelets or guides for fishing poles or rods of the present invention accomplishes all of the foregoing objectives and provides users with a device that enables for an improved fishing experience.

### SUMMARY OF THE INVENTION

The following presents a simplified summary in order to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises snag free eyelets for fishing poles or rods. The device is a fishing pole with eyelets or guides that enables the pole to be snag free, thereby preventing fishing line from wrapping around the fishing pole and obstacles from snagging the guides. A cotter pin is opened over the top of the eyelet and can accommodate the wrapped line. Electrical tape, guide wrappings, or guide winding thread can be used to secure the pin for stability. Looking at a side view of the eyelet, there is a wire that makes a ‘roof’ over the eye parallel with the fishing pole. Thus, the fishing line can easily slip through the eyelet/guide and avoid snagging, and obstacles can easily slip or slide over the eyelet/guide.

In one embodiment, the snag free eyelets for fishing poles or rods of the present invention assists any setting in which fishing is performed. The snag free eyelets for fishing poles or rods provides users with a snag free fishing pole that facilitates simple and convenient threading of the fishing line through the eyelets. The snag free eyelets for fishing poles or rods eliminates the need to constantly pull a pole back in and unhook the line after the eyelets. The snag free eyelets for fishing poles or rods makes it much easier and simpler for fishing line to transfer in and out of (i.e., through) the eyelets as the line is cast. The snag free eyelets for fishing poles or rods improves the overall fishing experience, reducing the amount of fishing line tangles and guide damage that can occur.

In one embodiment, the snag free eyelets for fishing poles or rods comprises a fishing pole shaft. The fishing pole shaft is typically configured in a cylindrical shape but can be configured in any suitable shape as is known in the art. Typically, the fishing pole shaft comprises a variety of eyelets along its length. In use, fishing line is thread through these eyelets.

In one embodiment, the device comprises a cotter pin. The cotter pin is opened over the top of an eyelet so that the pin is generally parallel with the fishing pole shaft and perpendicular to the eyelet. The cotter pin may be secured to the fishing pole shaft with electrical tape, guide wrappings, or guide winding thread for added stability. Thus, the fishing line can easily slide over the eyelet on the surface of the pin, preventing snags.

In one embodiment, the snag free eyelets for fishing poles or rods in accordance with the present invention can be produced in various colors, designs, patterns, etc., and feature logos, emblems, and or designs, such as a distributor requests and/or a user desires.

In one embodiment, the snag free eyelets for fishing poles or rods are manufactured of aluminum or high-density polyethylene (HDPE), or any other suitable materials as is known in the art. Any number of different types of materials can be used to make the snag free eyelets for fishing poles or rods including, but not limited to, plastics, metals, metal alloys, etc.

In use, the user opens the cotter pin over the top of an eyelet so that it is generally parallel with the fishing pole shaft and perpendicular to the eyelet. Next, the user secures the cotter pin to the fishing pole shaft with electrical tape, guide wrappings, or guide winding thread. Further, the user threads fishing line through the eyelet(s). Finally, the user utilizes the device while fishing. Thus, the snag free eyelets for fishing poles or rods improves the overall fishing experience, reducing the amount of fishing line tangles that occur while casting line, retrieving line, and/or retrieving fish.

It will also be appreciated that there are a number of additional add-on features that can be incorporated into the device and moreover, the snag free eyelets for fishing poles or rods can take many different forms as is known in the art.

In yet another embodiment, the snag free eyelets for fishing poles or rods comprises a plurality of indicia.

In yet another embodiment, a method of conveniently threading fishing line through the eyelets and utilizing the device to fish is disclosed. The method includes the steps of providing snag free eyelets for fishing poles or rods comprising a fishing pole shaft, eyelets, an overguide, fishing line, and electrical tape, guide wrappings, or guide winding thread. The method also comprises opening the cotter pin over the top of an eyelet so that it is generally parallel (i.e., aligned) with the fishing pole shaft and perpendicular to the eyelet. Next, the method comprises securing the cotter pin, or overguide, to the fishing pole shaft with electrical tape, guide wrappings, or guide winding thread. Further, the method comprises threading fishing line through the eyelet(s). Finally, the method comprises utilizing the device while fishing (i.e., casting and retrieving fishing line).

Numerous benefits and advantages of this invention will become apparent to those skilled in the art to which it pertains, upon reading and understanding the following detailed specification.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a perspective view of one embodiment of the snag free eyelets for fishing poles or rods of the present invention in accordance with the disclosed architecture;

FIG. 2 illustrates another perspective view of one embodiment of the snag free eyelets for fishing poles or rods of the present invention in accordance with the disclosed architecture;

FIG. 3 illustrates another perspective view of one embodiment of the snag free eyelets for fishing poles or rods of the present invention in accordance with the disclosed architecture;

FIG. 4 illustrates another perspective view of one embodiment of the snag free eyelets for fishing poles or rods of the present invention in accordance with the disclosed architecture;

FIG. 5 illustrates another perspective view of one embodiment of the snag free eyelets for fishing poles or rods of the present invention in accordance with the disclosed architecture; and

FIG. 6 illustrates a flowchart showing the method of conveniently threading fishing line through the eyelets and utilizing the device to fish in accordance with the disclosed architecture.

### DETAILED DESCRIPTION OF THE PRESENT INVENTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there is a long-felt need in the art for snag free eyelets for fishing poles or rods that provides users with a snag free, convenient, and simple threading of fishing line through the eyelets. There is also a long-felt need in the art for snag free eyelets for fishing poles or rods that eliminates the need to constantly pull a pole back in and unhooking the line after the eyelets. Further, there is a long-felt need in the art for snag free eyelets for fishing poles or rods that makes it much easier and simpler for fishing line to transfer in and out of the eyelets as the fishing line is cast. Finally, there is a long-felt need in the art for snag free eyelets or guides for fishing poles or rods that improves the overall fishing experience, reducing the amount of fishing line tangles that occur.

The present invention, in one exemplary embodiment, is a novel snag free eyelet or guide for fishing poles or rods that provides users with a snag free fishing pole that facilitates simple and convenient threading of fishing line through the eyelets. The device is a fishing pole with eyelets or guides that enables the pole to be snag free, thereby preventing fishing line from wrapping around the fishing pole. A cotter pin is opened over the top of the eyelet and can accommodate the wrapped line. Electrical tape, guide wrappings, or guide winding thread can be used to secure the pin for stability. Looking at a side view of the eyelet, there is a wire that makes a ‘roof’ over the eye parallel with the fishing pole. Thus, the fishing line, and other items contacting the guides, can easily slip or slide over the guide or eyelet and avoid snagging.

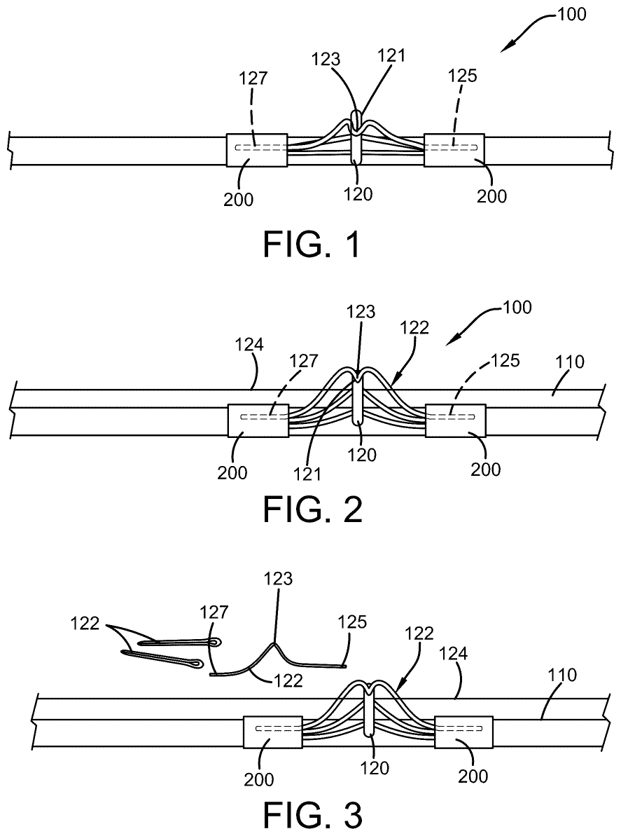

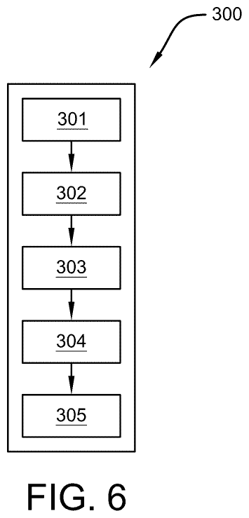

Referring initially to the drawings, FIGS. 1-5 illustrate a variety of perspective views of one embodiment of the snag free eyelets or guides for fishing poles or rods 100 of the present invention. In one embodiment, the snag free eyelets or guides for fishing poles or rods 100 comprises a fishing pole shaft or blank 110. The fishing pole shaft or blank 110 is typically configured in a cylindrical shape but can be configured in any suitable shape as is known in the art. Typically, the fishing pole shaft or blank 110 comprises a variety of eyelets or guides 120 along its length. In use, fishing line 124 is thread through these eyelets or guides 120.

In one embodiment, the device 100 comprises an overguide, cotter pin, or twisted (i.e., bent) pin 122. The overguide or twisted (i.e., bent) pin 122 is opened over the top of an eyelet 120 so that the overguide or twisted (i.e., bent) pin 122 is generally parallel with the fishing pole shaft or blank 110 and perpendicular to the eyelet 120. The overguide or twisted (i.e., bent) pin 122 includes opposing ends 125, 127 that are secured to the fishing pole shaft or blank 110 with electrical tape, guide wrappings, or guide winding thread 200 wrapped around opposing ends 125, 127 of the overguide 122. When installed, the overguide 122 includes an apex 123 that is adjacent to the outer perimeter or edge 121 of the guide 120. The outer edge 121 of the guide 120 is the distal edge 121 of the guide 120 relative to the fishing pole shaft 110. Thus, the fishing line 124, and other items contacting the guides, can easily slide over the guide or eyelet 120 on the surface of the overguide or twisted (i.e., bent) pin 122, thereby preventing snags to the fishing line and preventing damage to the fishing guides.

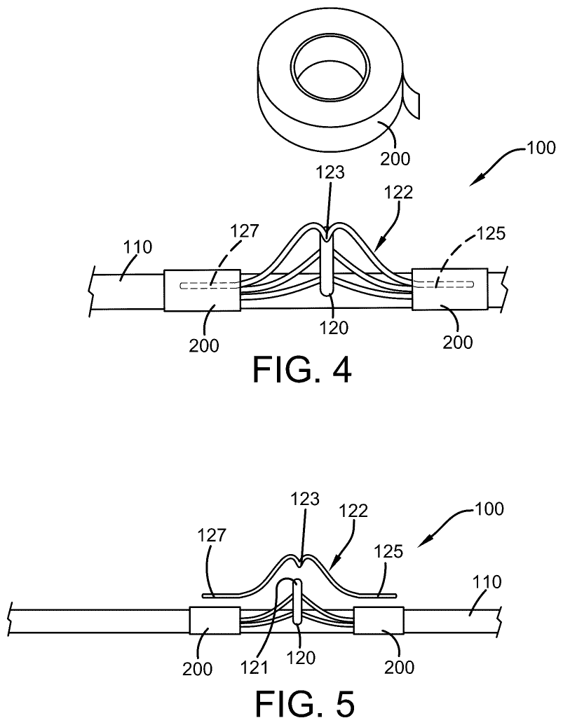

As shown in FIG. 4, the snag free eyelets or guides for fishing poles or rods 100 in accordance with the present invention can be produced in various colors, designs, patterns, etc., and feature logos, emblems, and or designs, such as a distributor requests and/or a user desires.

In one embodiment, the snag free eyelets or guides for fishing poles or rods 100 is manufactured of aluminum, or any other suitable material as is known in the art. Any number of different types of materials can be used to make the snag free eyelets or guides for fishing poles or rods 100 including, but not limited to, metals, metal alloys, heat-sealable plastic or polymers, such as polypropylene or acrylonitrile-butadiene-styrene (ABS), or any other suitable material as is known in the art, such as, but not limited to, colors, acrylic, polycarbonate, polyethylene, polyethylene terephthalate, polyvinyl chloride, polystyrene, etc. Generally, the snag free eyelets or guides for fishing poles or rods 100 is also manufactured from a material that is water resistant or waterproof or comprises a coating that is water resistant or waterproof.

In yet another embodiment, the snag free eyelets or guides for fishing poles or rods 100 comprises a plurality of indicia 400. The device 100 may include advertising, a trademark, or other letters, designs, or characters, printed, painted, stamped, or integrated into the device 100, or any other indicia 400 as is known in the art. Specifically, any suitable indicia 400 as is known in the art can be included, such as, but not limited to, colors, patterns, logos, emblems, images, symbols, designs, letters, words, characters, animals, advertisements, brands, etc., that may or may not be fishing, fishing line, or brand related.

It will also be appreciated that there are a number of additional add-on features that can be incorporated into the device 100 and moreover, the snag free eyelets or guides for fishing poles or rods 100 can take many different forms as is known in the art.

FIG. 6 illustrates a flowchart of the method 300 of conveniently threading fishing line through the eyelets and utilizing the device to fish. The method includes the steps of at 301, providing snag free eyelets or guides for fishing poles or rods comprising a fishing pole shaft, eyelets, an overguide, fishing line, and electrical tape, guide wrappings, or guide winding thread. The method also comprises at 302, opening the cotter pin over the top of an eyelet so that it is generally parallel with the fishing pole shaft and perpendicular to the eyelet. Next, the method comprises at 303, securing the cotter pin to the fishing pole shaft with electrical tape, guide wrappings, or guide winding thread. Further, the method comprises at 304, threading fishing line through the eyelet(s). Finally, the method comprises at 305, utilizing the device while fishing.

Certain terms are used throughout the following description and claims to refer to particular features or components. As one skilled in the art will appreciate, different users may refer to the same feature or component by different names. This document does not intend to distinguish between components or features that differ in name but not structure or function. As used herein “snag free eyelets or guides for fishing poles or rods”, “fishing pole device”, “eyelet device”, and “device” are interchangeable and refer to the snag free eyelets or guides for fishing poles or rods 100 of the present invention.

Notwithstanding the foregoing, the snag free eyelets or guides for fishing poles or rods 100 of the present invention can be of any suitable size and configuration as is known in the art without affecting the overall concept of the invention, provided that it accomplishes the above-stated objectives. One of ordinary skill in the art will appreciate that the snag free eyelets or guides for fishing poles or rods 100 as shown in FIGS. 1-5 is for illustrative purposes only, and that many other sizes and shapes of the snag free eyelets or guides for fishing poles or rods 100 are well within the scope of the present disclosure. Although the dimensions of the snag free eyelets or guides for fishing poles or rods 100 are important design parameters for user convenience, the snag free eyelets or guides for fishing poles or rods 100 may be of any size that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all of the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications, and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A snag free guide for a fishing pole comprising:
a fishing pole shaft;
a fishing line guide;
a fishing line; and
an overguide;
wherein said overguide is aligned with a length of said fishing pole shaft; and
further wherein said overguide having an apex proximal to an outer edge of said fishing line guide.

2. The snag free guide for a fishing pole of claim 1, wherein said overguide having a pair of opposing mounting ends for mounting to said fishing pole shaft.

3. The snag free guide for a fishing pole of claim 2, wherein said pair of opposing mounting ends having guide wrappings surrounding said pair of opposing mounting ends for mounting to said fishing pole shaft.

4. The snag free guide for a fishing pole of claim 3, wherein said fishing pole having a plurality of fishing line guides spaced along a length of said fishing pole shaft, and further wherein each one of said plurality of fishing line guides having an associated said overguide mounted thereto.

5. The snag free guide for a fishing pole of claim 4, wherein said fishing line is thread through said plurality of fishing line guides.

6. The snag free guide for a fishing pole of claim 3, wherein said overguide comprises a bent pin.

7. The snag free guide for a fishing pole of claim 3, wherein said overguide is an opened cotter pin.

8. The snag free guide for a fishing pole of claim 2, wherein said pair of opposing mounting ends having guide winding thread surrounding said pair of opposing mounting ends for mounting to said fishing pole shaft.

9. The snag free guide for a fishing pole of claim 2, wherein said overguide perpendicular to said fishing line guide.

10. A snag free guide for a fishing pole comprising:
a fishing pole shaft;
a fishing line guide;
a fishing line; and
an overguide;
wherein said overguide is aligned with a length of said fishing pole shaft;
wherein said overguide having an apex proximal to an outer edge of said fishing line guide;
wherein said overguide having a pair of opposing mounting ends for mounting to said fishing pole shaft;
wherein said pair of opposing mounting ends having guide wrappings surrounding said pair of opposing mounting ends for mounting to said fishing pole shaft; and
further wherein said overguide perpendicular to said fishing line guide.

11. The snag free guide for a fishing pole of claim 10, wherein said fishing pole having a plurality of fishing line guides spaced along a length of said fishing pole shaft, and further wherein each one of said plurality of fishing line guides having an associated said overguide mounted thereto.

12. The snag free guide for a fishing pole of claim 10, wherein said fishing line is thread through said plurality of fishing line guides.

13. The snag free guide for a fishing pole of claim 10, wherein said overguide comprises a bent pin.

14. The snag free guide for a fishing pole of claim 10, wherein said overguide is an opened cotter pin.

15. The snag free guide for a fishing pole of claim 10, wherein said pair of opposing mounting ends having guide winding thread surrounding said pair of opposing mounting ends for mounting to said fishing pole shaft.

16. A method of providing a snag free guide for a fishing pole, the method comprising the steps of:
providing a fishing pole shaft, a fishing line guide, a fishing line, and an overguide;
wherein said overguide having an apex proximal to an outer edge of said fishing line guide, further wherein said overguide having a pair of opposing mounting ends;
aligning said overguide with a length of said fishing pole shaft;
mounting said pair of opposing ends to said fishing pole shaft;
wrapping said pair of opposing ends with guide wrappings surrounding said pair of opposing mounting ends and said fishing pole shaft; and
securing said overguide to said fishing pole shaft, wherein said overguide perpendicular to said fishing line guide.

17. The method of providing a snag free guide for a fishing pole of claim 16, wherein said fishing pole having a plurality of fishing line guides spaced along a length of said fishing pole shaft, and further wherein each one of said plurality of fishing line guides having an associated said overguide mounted thereto.

18. The method of providing a snag free guide for a fishing pole of claim 16, wherein said fishing line is thread through said plurality of fishing line guides.

19. The method of providing a snag free guide for a fishing pole of claim 16, wherein said pair of opposing mounting ends having guide winding thread surrounding said pair of opposing mounting ends for mounting to said fishing pole shaft.

20. The method of providing a snag free guide for a fishing pole of claim 16, wherein said overguide is an opened cotter pin.
